(19) United States
(12) Patent Application Publication
(10) Pub. No.: US 2007/0209528 A1
(43) Pub. Date: Sep. 13, 2007

(54) Blender

(76) Inventor: Ming-Shih Chang, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/798,204

(22) Filed: May 11, 2007

Related U.S. Application Data
(63) Continuation-in-part of application No. 10/946,551, filed on Sep. 22, 2004, now abandoned.
(63) Continuation-in-part of application No. 11/410,907, filed on Apr. 26, 2006.
(63) Continuation-in-part of application No. 11/341,424, filed on Jan. 30, 2006, now abandoned.

(51) Int. Cl. A23N 1/00

(52) U.S. Cl. 99/511

(57) ABSTRACT

The present invention is related to a blender, particularly to a blender having a blade disk formed with dreg-expel holes in front of leading edges of blades of inner circle, and a ring-typed cover added below a feed chute as well as being hung over the blade disk to keep gaps in between, thereby it can get pulp contained with juice; which introduces less air thereinto, further enzymes found in raw vegetables and fruits may not be destroyed.

### CROSS REFERENCE TO RELATED APPLICATION

The present invention is a C-I-P application related to the application assigned Ser. No. 10/946,551 published on Mar. 23, 2006, Ser. No. 11/410,907 published on Aug. 31, 2006, Ser. No. 11/341,424 filed on Jan. 30, 2006 now is abandoned.

### FIELD OF THE INVENTION

The present invention is related to a blender, particularly to a blender having a blade disk formed with dreg-expel holes in front of leading edges of blades of inner circle, and a ring-typed cover added below a feed chute as well as being hung over the blade disk to keep gaps in between, thereby it can get pulp contained with juice; which introduces less air thereinto, further enzymes found in raw vegetables and fruits may not be destroyed.

### GROUND OF THE INVENTION

To squeeze fruit or vegetable, for a pulp contained juice is popular to serve as healthy foodstuff and fresh ingredients added to fruit pies, cake decorations, or appetizers, even being processed as nutrition supplements for the patients and children.

However, faster moving parts introduce more air into the pulp and juice, and therefore oxidize important nutrients more quickly. It has also been said that the heat generated from the machine and the friction of centrifugal juicers destroy enzymes found only in raw vegetables and fruits (because of the damage done during the cooking or heating process), thereby defeating the purpose of pulverizing or juicing. Blenders with variable speeds are regarded as being of higher quality.

A continuous range of rotations per minute (RPM) of the blade disk to pulverize vegetables or fruits, or even crack nut kernel without shell sometimes is prepared by a blender rotated at a moderate to slow speed, most of valuable nutrients be kept within those processed foodstuffs. Therefore, a centrifugal force is also reduced relative to such a moderate to slow requirement. Since a blender is designed for getting a pulp, but not for juicing; therefore, a fresh and nutrient pulp contained juice can be expected from a “slower” but more efficient blender. That is, the blade disk can be designed to eliminate the dregs or pulps from building up on the disk, further to avoid them from being clogged with the blade disk and feed chute to get pulverized pulps as desired.

To improve such problems, a plunger is usually provided for pushing the foodstuffs moved away from the inner circle of the blade disk. Although it may lead a user timely inserts a plunger into the feed chute to press chopped ingredients. Persons skilled in the art have provided a safety mechanism coupled to such a plunger, such as US published number 20050127086 entitled “Food Processing Device” to Luke Charles Bradshaw et al. published on Jun. 16, 2005. It taught that a plunger may be inserted into a feed chute in one orientation, a raised elongate ridge along the plunger is engaged with a slot inside the feed chute formed with a catch, by whose projection end a trapdoor pivoted by a sprung hinge is held in generally a closed position, only insertion of the plunger, the catch is forced against spring, causing the projection end of the catch travel back away from the central axis of the feed chute. In this way, the trapdoor 140 is unlocked. Or similar magnets provided to the plunger and the feed chute, magnetic repulsion causing the catch to move away from the feed chute to unlock the trapdoor. The plunger may be inserted into the feed chute in any orientation as no raised elongate ridge is required. The hinged end 142 of the trapdoor 140 must be positioned at a distance above the blade at least equal to the diameter of the feed chute. For wider chutes, this can result in a longer chute than would otherwise be desirable.

Or such as TW493417 entitled “an improved structure of an extractor” assigned to Rong-Yuan Tseng et al. on Jul. 1, 2002, a disk having three cambered blades as an inner circle, of which a longest blade extending across a center of the disk to eliminate a dead space thereof. A plurality of teeth arranged around the inner circle as an outer circle. Thereby, by a centrifugal force, foodstuff chopped in the inner circle can be further pulverized by the teeth of the outer circle. Those blades and teeth arrayed to form inner and outer circles are not suitable for reducing pulps or dregs occasionally built up therein, even the pulp contained juice or dregs are not pulverized as desired.

However, the disk of TW493417 is mainly divided into an inner and an outer circles, what is chopped through the inner circle must be implemented by a centrifugal force to dispel to the outer circle; and the plunger of U.S. application Ser. No. 10/972,469 inserted into a feed chute in any orientation by similar magnets installed thereto, whose magnetic field only attracted by steel or the like, it could be interfered with edible vegetable grease or others build up and being clogged with the plunger or the channel continual disregard magnetism or the like up for safety mechanism.

Since a diameter of the disk usually is designed at a range no less then 12 cm. As always, an enlarged disk is to prolong the grinding duration of a fruit or vegetable, while in practice, the enlarged disk is yet to increase the grinding effect with more air introduced therein. How can we provide a disk can get pulp contained juice more efficient for a blender than the prior arts; an outflow-dreg disk for dispelling dregs at an inner circle, and a ring-type cover added below the feed chute at gaps to the blade disk for pulverizing fruits or vegetables may be worth your while for operating such a blender.

### SUMMARY OF THE INVENTION

Accordingly, an object of the present invention is to expel dregs or pulps contained juice built up on an inner circle of a blade disk promptly to avoid a dead space remained inside a central portion of the blade disk.

Another object of the present invention is to reduce the area of the blade disk; the volume of a blender can also be reduced.

Another object of the present invention is to maintain an aperture of a feed chute circular in shape to pass the fruit or vegetable into the blender.

Another object of the present invention is to increase efficiency of pulverizing fined pulps at gaps extended between a ring shaped blade disk cover added below the feed chute and being hung over the blade disk.

Point against aforesaid defects of the prior arts, the present invention is to provide a blender 20 comprising a lower housing 1 having a motor 11 mounted therein, a base 3 assembled to a shaft 51 of the motor 11 as a whole, a ring-type container 8 assembled to the lower housing 1 on top of the base 3 to receive an outflow-dreg disk 2 having a central inner circle 21 and an outer circle 22 surrounds the inner circle 21; said inner circle 21 is equipped with cambered blades 23, said outer circle 22 is equipped with teeth 24; characterized in that dreg outflow holes 25 formed in front of leading edges 231 of the cambered blades 23 respectively to expel the dregs downwardly, fruit or vegetable is in contact with the inner and outer circle at the same time, the dregs of the outer circle can be expelled out from the disk by centrifugal force, while the dreg of the inner circle can be expelled downward throughout the dreg outflow holes; the base 3 assembled to a shaft 51 of motor 11, a number of props 32 protruded out from a bottom inside the base 3 adapted and fixed to holes 26 of the blade disk 2 by fixtures to accommodate an outflow space A between the blade disk 2 and the base 3.

Accordingly, the present invention is further to provide a blender 20 comprising a lower housing 1 having a motor 11 mounted therein, a blade disk 2 having a base 3 assembled to a shaft 51 of the motor 11 as a whole, a ring-type container 8 assembled to the lower housing 1 on top of the base 3 to receive the blade disk 2 with the base 3 therein, a sieve is screwed to the base 3 with the blade disk 2 concentrically, an upper housing 6 is disposed above the ring-type container 8, and a plunger 7 can be inserted through a feed chute 61 thereof, characterized in that:

A ring-type blade disk cover 9 is added below the feed chute 61, the blade disk cover 9 is extended with a horizontal plate 92 hung over the blade disk 2 at a first gap 9a to an upper surface of the blade disk 2, further a side wall 93 of the horizontal plate extended downward at a second gap 9b to a rim of the blade disk 2, whereby shredded fruits can be pulverized into pulps.

Where the blade disk cover added below the feed chute and being hung over the disk is helpful to the grinding job. Further, the ring-type cover is not only horizontally hung over the disk to keep a first gap therebetween, but also is extended downward with a sidewall at a vertical angle to keep a second gap from a rim of the disk.

### ADVANTAGE OF EMBODIMENTS OF THE INVENTION

After the blade disk cover added below the feed chute of the upper housing, shredded fruits can be macerated between the blade disk cover and the blade disk, because first, second gaps kept between them, the shredded fruits can be macerated to form pulp contained juice.

The sieve is mainly constructed by a base impervious to water and a frame may be adorned with grids or meshes as a wall to surround the base. Though getting pulp contained juice is first flowing to the sieve, most of pulps still can be led into the container through the sieve to preserve nutrients without introducing air, further, the pulp remained within the sieve may not be oxidized to destroy nutrients in vegetable or fruit.

Further, a dreg outflow hole 25 formed through an inner circle 21 of the blade disk 2, each crescent shaped dreg outflow hole 25 formed in front of each leading edge of a cambered blade 23 respectively. The dreg outflow hole 25 is preferrable a little larger than the blade 23, before grinding a fruit or vegetable through the blades 23, slumps of a fruit or vegetable may be divided by the leading edges. After that, most of the sliced fruit or vegetable can be thrown out to the outer circle for a further grinding job, however, morsels or dregs of shredded vegetable or fruit may be built up and clogged with the inner circle, those morsels or dregs can be expelled out downwardly from the holes 25. Thereby, pulps contained juice may be produced throughout the inner and outer circles more efficiently; a sufficient supply of pulps contained juice can be proficiently gotten from such a dreg outflow disk.

After combination of the disk 2 and a base 3, an outflow space A kept between them is sufficient for expelling the dregs from the hole 25 normally.

Even an area of the disk 2 is reduced, further, the volume of the blender can be reduced, as a result, the blender is not designed as an enormous space-occupied apparatus, in use, it can be brought in person at one's convenience. Even the material cost in manufacturing can be cost down, and space-economy is fulfilled. Further, an aperture of the feed chute can be formed circular in shape; a fruit or vegetable for getting a pulp may pass through the feed chute promptly and easily.

### BRIEF DESCRIPTION OF THE DRAWINGS

FIG. 1: shows an exploded view of the first embodiment of the blender of the present invention;

FIG. 2: shows an assembled view of the first embodiment of the blender of the present invention;

FIG. 3: shows a sectional view of the ring type blade disk cover hung over a blade disk with gaps spaced from the blade disk;

FIG. 4: shows an exploded view of the second embodiment, the ring type blade disk cover added below the feed chute;

FIG. 5: shows a sectional view of the second embodiment, the ring type blade disk cover added below the feed chute with gaps spaced from the blade disk of FIG. 4;

FIG. 6: shows a cross sectional view of the blender;

FIG. 7: shows an exploded view the third embodiment of blade disk of the present invention;

FIG. 8: shows an assembled view of the third embodiment of the blade disk of the present invention;

FIG. 9: shows a top plan view of the third embodiment of the blade disk of the present invention;

FIG. 10: shows a sectional view of the third embodiment of the blade disk of the present invention;

FIG. 11: shows a schematic view of the flow out dreg process throughout the inner circle of the blade disk;

FIG. 12: shows a schematic view of the of the blade disk of the present invention (in solid line), whose area is reduced than a conventional metal blade disk (in dotted line); and

### DETAILED DESCRIPTION OF THE PREFERRED EMBODIMENTS

### First Embodiment

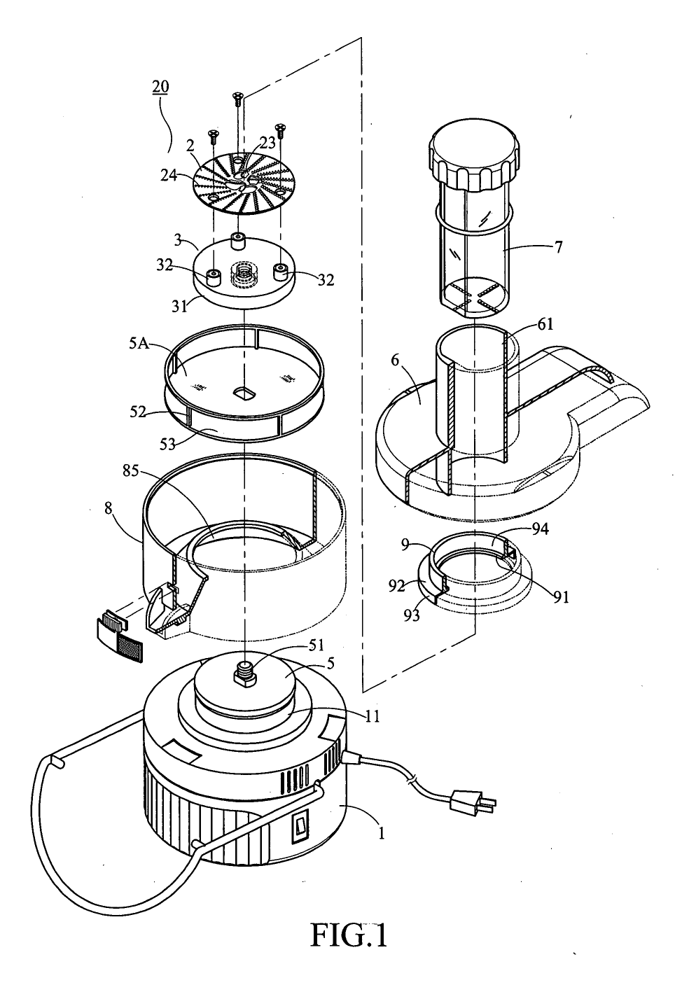

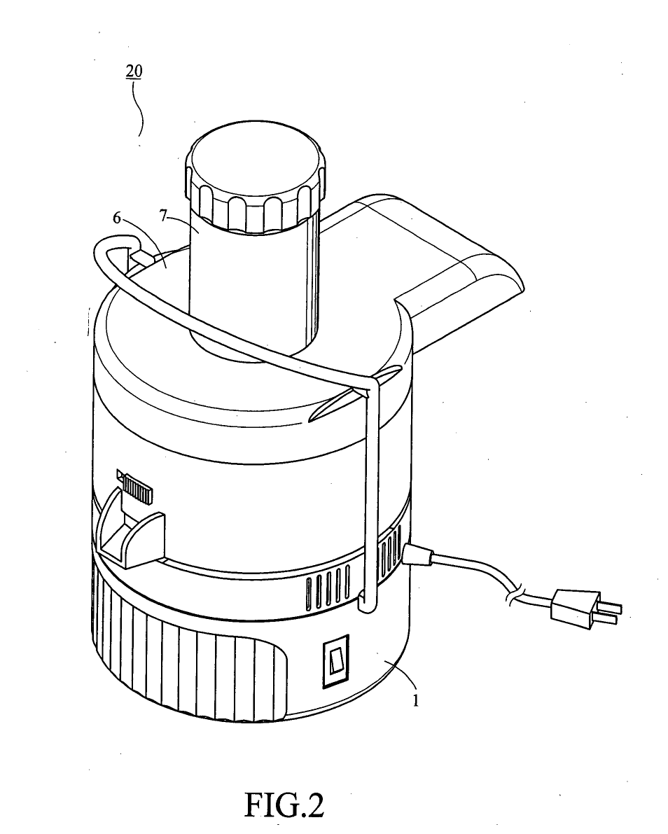

As shown in FIG. 1, a first embodiment of the present invention is illustrated. In that, a blender 20 includes a lower housing 1 having a motor 11 with a shaft 51 mounted inside thereof, a base 3 assembled to the shaft 51 of the motor 11 as a whole, a ring type container 8, a blade disk 2, a sieve 5A with a frame 52 and a base 53, an upper housing 6 with a feed chute 61 having an aperture circular in shape centrally formed therethorugh, and a plunger 7. Further a ring type blade disk cover 9 is added below the feed chute 61 further being extended above the blade disk 2. After assemblage, the assembled blender is illustrated as shown in FIG. 2.

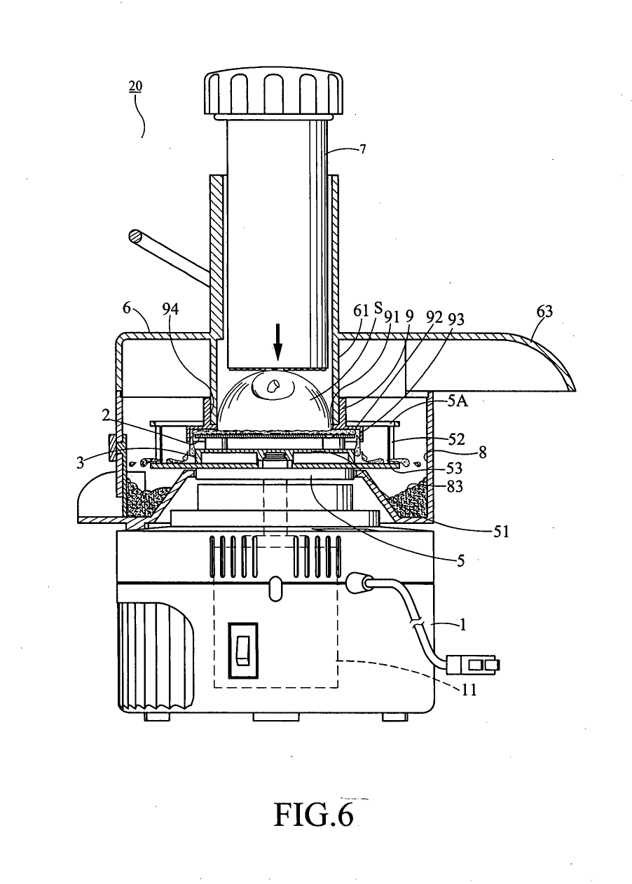

Once the ring type blade disk cover 9 assembled to the feed chute 61, the sieve 5A with the frame 52 for temporarily storing dregs or pulps, the frame may be adorned with meshes or grids, further can be shaped as a wall 52 instead of the frame surrounds the base 53 (illustrated as in FIG. 1) to collect fresh and pulverized foodstuff as soon as possible, if desired. Furthermore, a height of the frame or wall of the sieve 5A can be lowered due to a funnel like device can be omitted in between. Where an amount of dregs or pulps can be overflowed or flowed out to the container 8. In addition, the base 53 is applied to prevent the pulp contained juice from draining out through a central bore 85 of the ring type container 8. Although the base of the sieve 5A is impervious to water, most of the dregs or pulps (as illustrated in FIG. 6) flow into the ring type container 8 by centrifugal force.

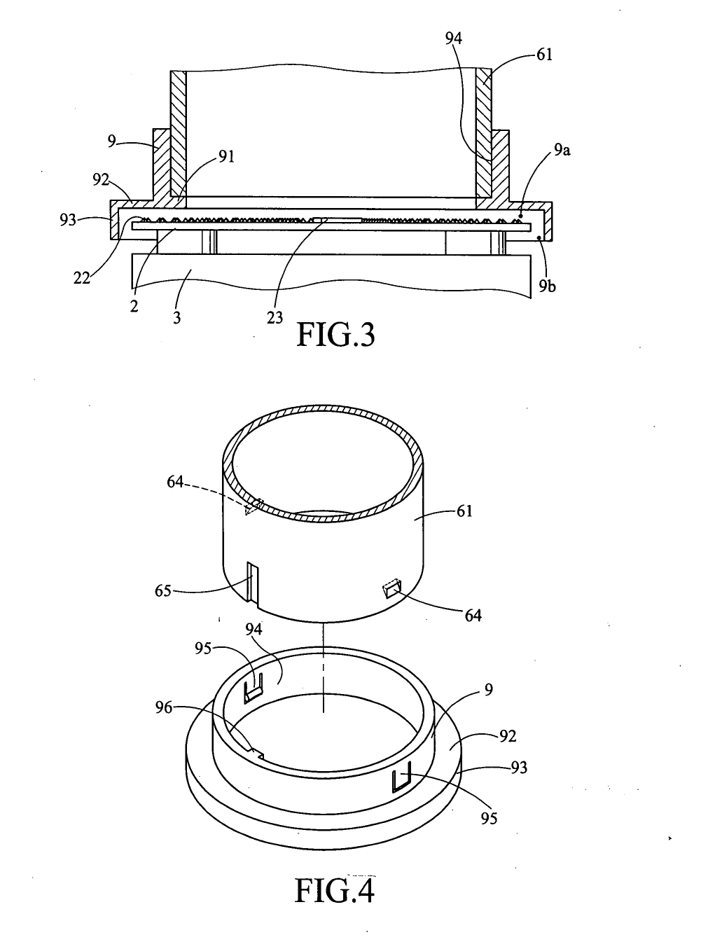

As shown in FIG. 3, a ring type blade disk cover 9 with a central bore 94 added below the feed chute 61, the ring type blade disk cover 9 has a horizontal flange 91 projected inwardly along the central bore 94, the flange 91 can be used to adapt to a bottom of the feed chute 61 as an obstruction to the feed chute. Where the ring type blade disk cover 9 can be coupled together to the feed chute 61 promptly. Though the central bore 94 of the ring type blade disk cover 9 in diameter is larger than the aperture of the feed chute, but the flange 91 of the ring type disk cover 9 is extended inwardly to fit flush against an inner wall of the aperture of the feed chute. Moreover, opposite to the flange, the ring type blade disk cover has a plate 92 extended outwardly and horizontally from the central bore 94 to a rim to cover up all the blade disk 2, the horizontal plate 92 is substantially hung over the blade disk 2 at a first gap 9a, which is vertically spaced from the blade disk 2.

Furthermore, a sidewall 93 is extended downward vertically from the plate 92 of the ring type blade disk cover to surround the blade disk 2 at a second gap 9b proximally and horizontally spaced from a rim of the blade disk 2. Thereby, when grinding, finally the pulp contained juice can flow along the first, second gaps 9a, 9b by centrifugal forces, while the sidewall 93 extended downward can further pulverizing the shredded fruits or vegetables into pulp contained sufficient juice due to the gaps 9a, 9b is to obstruct an amount of shredded fruits or vegetables until they are macerated more evenly.

After assemblage, in use, a sectional view of the assembled blender is illustrated as shown in FIG. 6. Pulverized pulps 83 contained juice are flown from the sieve 5A whose base is impervious to water to the container 8.

### Second Embodiment

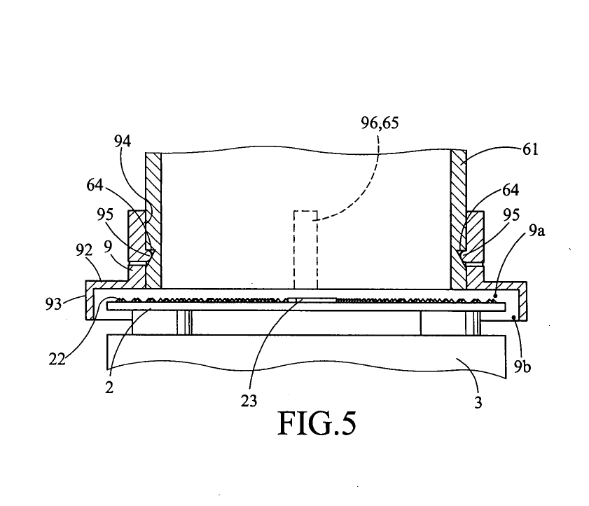

As shown in FIGS. 4 and 5, a ring type blade disk cover 9 is assembled to the feed chute 61 different from the first embodiment. Two plastic buttons 95 projected inwardly from a central bore 94 of the ring type blade disk cover 9 can be embedded into two corresponding troughs 64 formed along an outer wall of the feed chute 61. A vertical tenon 96 projected inwardly from the central bore of the ring type blade disk cover 9 can be glided along a vertical trough 65 formed along an outer wall of the feed chute 61, the tenon 96 can be led into the trough 65 to eliminate rotated movements between the ring type blade disk cover and the feed chute.

### Third Embodiment

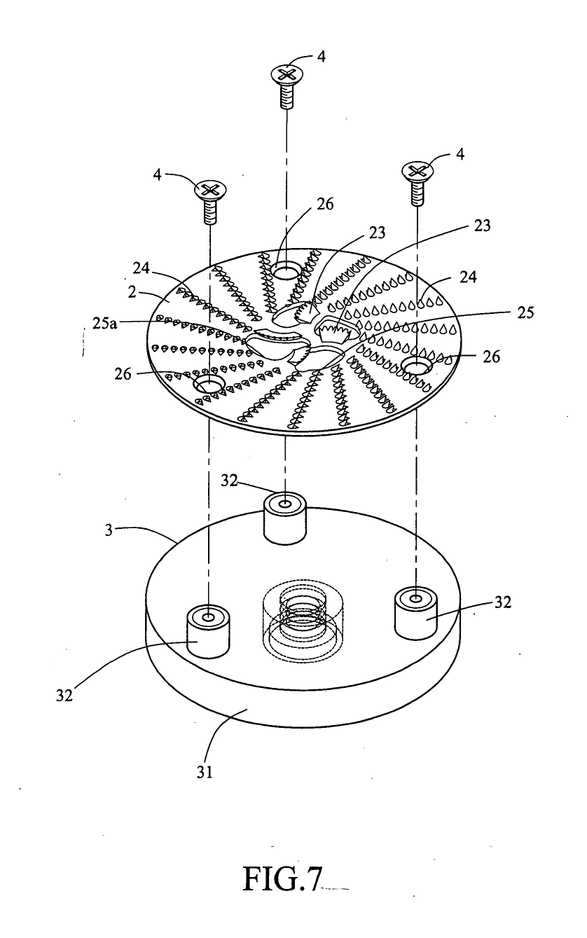

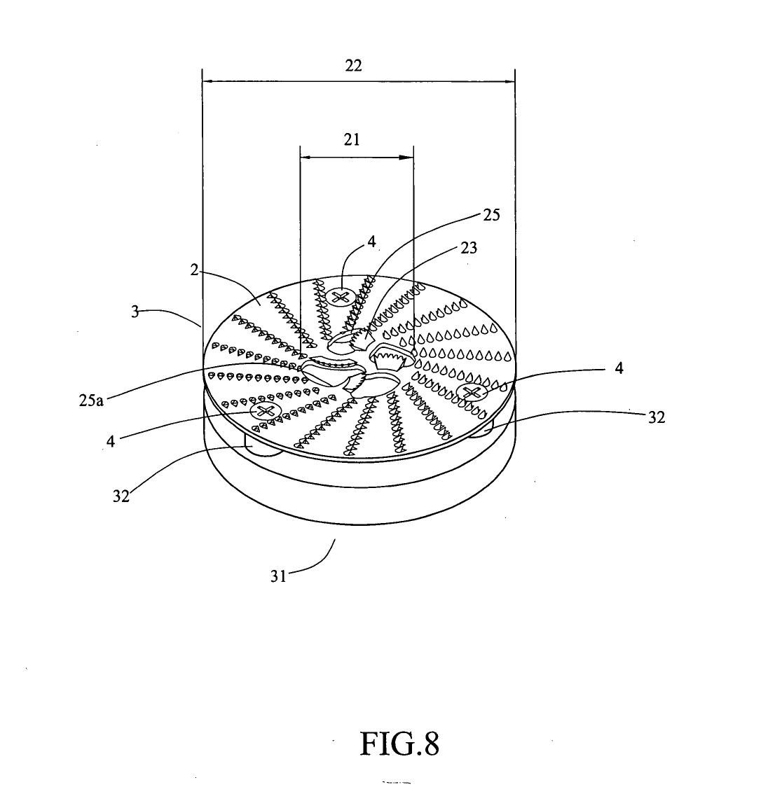

As shown in FIGS. 7 and 8, a disk assembly 1 comprises a blade disk 2 made of stainless steel and a base 3 made of plastic steel, the disk and the base are secured to each other by screws 4 coupled to props 32 inside the base 3, the base 3 also has a central nut, thereby, the base can be assembled to a shaft 51 of a motor 11.

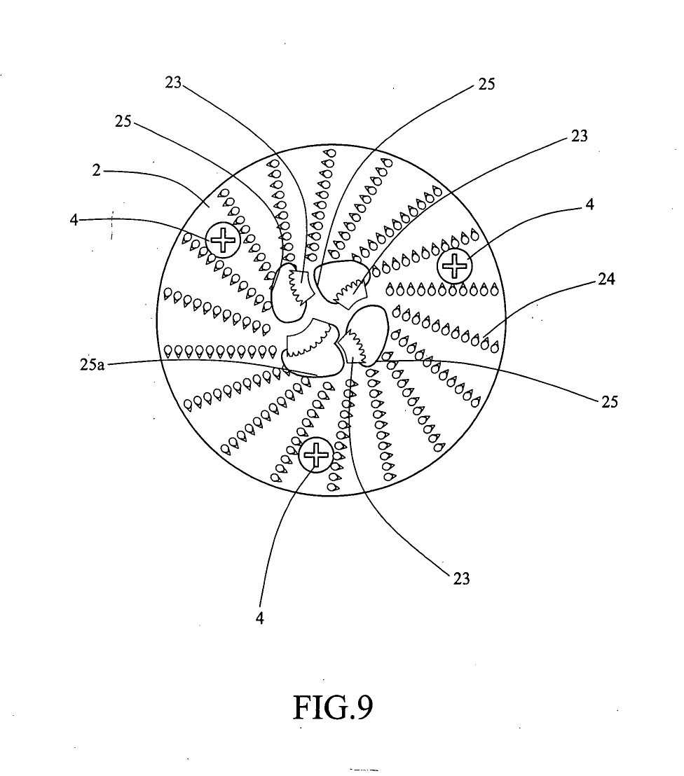

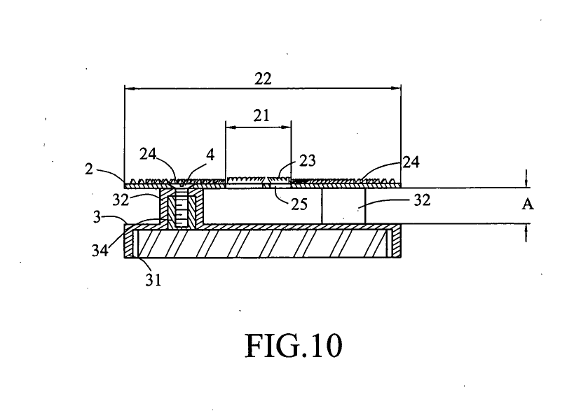

As shown in FIGS. 9 and 10, the blade disk 2 is circular in shape, an inner circle 21 and an outer circle 22 to a rim of the blade disk 2 (please see FIG. 10) are configured on an upper surface of the blade disk 2, the inner circle 21 having cambered blades 23 arranged as an intermittent loop or approximately shaped as a cross at a central smaller area of the blade disk 2, the outer circle 22 surrounds the inner circle to a rim of the blade disk 2 is occupied a larger area, a number of teeth 24 are radiated from the inner circle to the rim of the blade disk 2.

The blade disk 2 is punched to form a number of blades and teeth protruded out from the upper surface thereof. But each blade 23 is protruded upward as a cambered and raised edge, of which a leading edge 231 is sharp and tapered even formed as sawteeth for cutting vegetables or fruits directly into slices or cubes, in front of the leading edge of blade 23 is formed with a crescent shaped hole as an outflow dreg hole 25; where slumps of fruit or vegetable are to be clogged with the blade 23, through cutting or slicing by the leading edges 231, some morsels or dregs of sliced vegetable or fruit can be flowed or forced into the holes 25 formed in front of the leading edges, but most of the sliced vegetable or fruit are continually sliced into pieces and then thrown out to the outer circle processed through a further grinding process. In the third embodiment, it is exemplified that four cambered blades with four holes are separately formed in the inner circle. While a number of teeth 24 are spaced equidistantly to radiate from the inner circle to a rim of the blade disk 2 to form arrays of teeth.

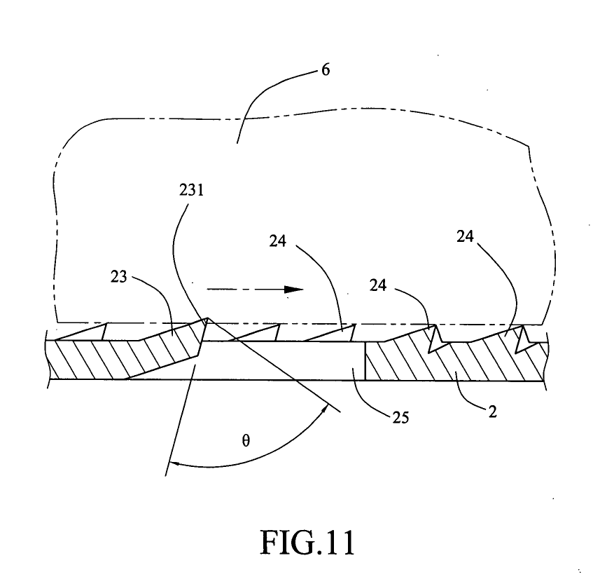

As shown in FIG. 11, one tapered and sharpened leading edge 231 at an acute angle is protruded from an upper surface of the blade 23 for cutting and slicing fruits or vegetables. The other trailing edge of the teeth 23 is shaped even and smooth at an obtuse and slopping angle, which is not suitable for slicing, or cutting. Such a raised edge is formed as cambered or straight shape, which is disclosed in the cited TW493417.

The inner circle 21 of the blade disk 2 being a smaller area, the outer circle 22 being a larger area, the ratio of inner and outer circle can be inferred from the comparison as following:
a. Radius of the inner circle 21 is expressed as r=1.5 cm, the area can be expressed as πr²=7.07 cm²
b. Radius of the blade disk 2 is expressed as r=4.5 cm, the area can be expressed as πr²=63.62 cm²
c. Area of the outer circle can be expressed as b-a=56.55 cm²

a:b:c=1:9:8, according to the ratios among them, the inner circle is only occupied one ninth (1/9) area of the blade disk 2, while the outer circle is occupied eight ninth (8/9) area of the blade disk. And the ratio of the inner circle to the outer circle is one eighth (1/8). The present invention is not confined by said ratio as described above. However, the ratio of radii a to b is preferrably arranged as 1.5 cm:4.5 cm=1:3 or approach to the 1:3 ratio.

As shown in FIGS. 7-9, four blades 23 distributed in the shape of an intermittent loop or probably a cross, which is characterized in that each dreg outflow hole 25 formed in front of each leading edge 231 of the blade 23. The dreg outflow hole 25 is a crescent shaped through hole, formed by punching, or the dreg outflow hole 25 can be shaped by hollowed-out or cut-out through the blade disk 2; the dreg outflow hole 25 is relative to the leading edge 231 of the teeth 23. The length of the dreg outflow hole is preferrably larger than the blade 23. When grinding, the morsels or dregs of sliced vegetable or fruit built up on the spot can be expelled downward throughout the hollowed dreg outflow hole 25. Nevertheless, one blade 23 is elongated than other blades 23, even a leading edge of this blade 23 is extended to a center of the blade disk, or passed across a center thereof. A dreg outflow hole 25a relative to the elongated blade 23 is the largest outflow hole of the blade disk.

As shown in FIG. 10, a base 3 made of plastic steel having several props 32 protruded out from a bottom inside the base 3, the props 32 are corresponding and adapted to the holes 26 of the blade disk 2, and then the props 32 are secured to the holes 26 by screwing with screws 4. Due to the props 32 are introduced between the blade disk 2 and base 3, an outflow space A constructed in between the disk 2 and the base 3 accommodates dregs to pass through and expel out. On the other hand, metal nuts 34 are embedded to the props 32 for fixing the fixtures such as screws 4 screwed to the blade disk 2. Thereby, the blade disk 2 is not detached from the blade base 3. Furthermore, a rim of the base 3 is preferrably a little larger than the blade disk 2. Under centrifugal force, the dregs expelled out downward from the dreg outflow hole 25 can be expelled out to the rim, and a little larger base 3 is suitable for adaptation to a sieve with meshes or grids (not shown).

As shown in FIGS. 6 and 11, when motor 11 starts to rotate the rotary disk 5 at moderate to slow speed, in turn, the blade disk is rotated synchronously. At this time, a fruit S or vegetable, for example, an apple is inserted into an aperture circular in shape of the feed chute 61 of the upper housing 6, the apple may be pressed by a plunger 7. The fruit S or vegetable is ground by the blade disk 2. Due to the fruit S or vegetable is in contact with the inner and outer circle at the same time, the dregs of the outer circle can be expelled out from the disk by centrifugal force, while the dregs of the inner circle can be expelled downward throughout the dreg outflow hole 25. Because the dregs expelled out of the inner and outer circle are not accumulated to a sieve with meshes or grids impervious to water or juice contained in the morsels or pulps, even the dregs substantially are pulps, can be used as jam.

As shown in FIG. 11, a fruit S or vegetable (not shown) is ground into the inner circle 21 of the blade disk 2, the leading edge 231 of the blade 23 is applied to slice, cut the fruit S or vegetable as the arrowhead indicated. The morsels or dregs are expelled downward throughout the dreg outflow hole 25, the expelled out morsels or dregs can be flown downward in the range of θ angle only. Without dreg outflow hole 25, the morsels or dregs in the inner circle can only be expelled outward to the rim by centrifugal force. But morsels or dregs may build up on the leading edge of blade, which can be formed likely sawteeth to divide the morsels into slices, otherwise the morsels or dregs may obstruct the outflow of dregs further being accumulated on the blade disk 2. In addition, sliced morsels or dregs are compressed between the fruit S or vegetable and the blade disk 2 as an obstruction. That leads to the fruit S or vegetable delayed passing through the feed chute. While in the present invention, a dreg outflow hole 25 in the inner circle can be applied to expel most of the dregs built up in the inner circle.

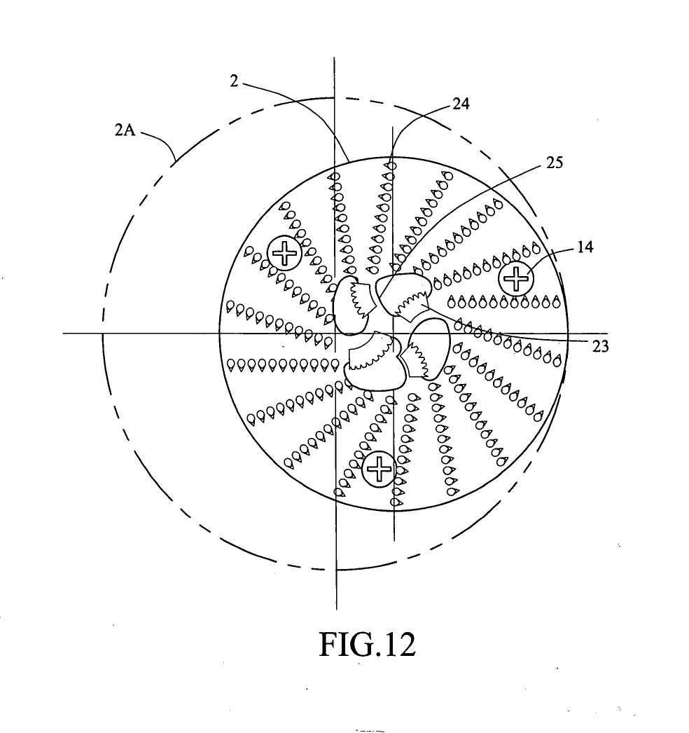

As shown in FIG. 12, the metal blade disk 2 of the present invention is compared with a conventional metal blade disk 2A drawn at 1:1 proportion between them. Due to the blade disk 2 is reduced to an area smaller than a conventional blade disk 2A, the volume of the blender can also be reduced. The reduced ratio of the blade disk of the present invention can be expressed as following:
A: radius of the blade disk 2 of the present invention is expressed as r=4.5 cm, the area or scope of the blade disk 2 can be expressed as πr²=63.6 cm²
B: radius of the conventional blade disk 2A is expressed as r=6 cm, the area or scope of the blade disk 2A can be expressed as πr²=113.1 cm²

A:B=1:1.8, according to the comparison between the areas of the blade disks 2, 2A, the blade disk 2 of the present invention is only equal to 1/1.8 of the conventional blade disk 2A. Therefore, the material cost of the blade disk 2 of the present invention can be reduced, which is economical and cost-effective than the conventional blade disk.

Due to the area of the blade disk 2 can be reduced than a conventional blade disk 2A; as a result, the volume of the blender can be reduced. But the aperture of the feed chute can be maintained as an original circular in shape, the diameter of the aperture can keep the same as the conventional blender to facilitate the fruit or vegetable passed through the feed chute and being ground by the blade disk.

What is we claimed:

1. A blender (20) comprising a lower housing (1) having a motor (11) mounted therein, a base (3) assembled to a shaft (51) of the motor (11) as a whole, a ring-type container (8) assembled to the lower housing (1) on top of the base (3) to receive an outflow-dreg disk (2) having a central inner circle (21) and an outer circle (22) surrounds the inner circle (21) to a rim of the blade disk, said inner circle (21) is equipped with cambered blades (23), said outer circle (22) is equipped with teeth (24) characterized in that:
dreg outflow holes (25) formed in front of leading edges (231) of the blades (23) respectively to expel the dregs downwardly, fruit or vegetable is in contact with the inner and outer circle at the same time, the dregs of the outer circle can be expelled out from the disk by centrifugal force, while the dreg of the inner circle can be expelled downward throughout the dreg outflow holes; a number of props (32) protruded out from a bottom inside the base (3) adapted and fixed to holes (26) of the blade disk (2) by fixtures to accommodate an outflow space (A) between the blade disk (2) and the base (3).

2. A blender (20) according to claim 1 wherein fixtures for fixing the base (3) to the blade disk (2) are metal screws (4), nuts (34) embedded into the props of the base (3) for securing the screws (4) by screwing.

3. A blender (20) according to claim 1 wherein the length of the dreg outflow hole (25) is larger than the blade (23).

4. A blender (20) comprising a lower housing (1) having a motor (11) mounted therein, a base (3) assembled to a shaft 51 of the motor (11) as a whole, a ring-type container (8) assembled to the lower housing (1) on top of the base (3) to receive a blade disk (2) therein, the blade disk (2) is also assembled to the shaft of the motor by the base (3), a sieve is screwed to the base (3) with the blade disk (2) concentrically, an upper housing installed above the ring-type container, and a plunger can be inserted through an aperture of a feed chute of the upper housing characterized in that:
a ring-type blade disk cover is added below the feed chute, the blade disk cover is extended with horizontal plate hung over the blade disk at a first gap to an upper surface of the blade disk, further a side wall of the horizontal plate extended downward at a second gap to a rim of the blade disk.

5. A blender according to claim 4 wherein said ring type blade disk cover having a flange projected inward inside a central bore for hindering a bottom of the feed chute.

6. A blender according to claim 4 wherein said ring type blade disk cover having two plastic buttons projected inward can be embedded into two corresponding troughs formed on an inner wall of the feed chute, the central bore of the ring type blade disk cover having a tenon protruded inward from a top edge thereof, can be vertically glided into a trough formed on an inner wall of the feed chute.
